(19) United States
(12) Patent Application Publication
(10) Pub. No.: US 2015/0073318 A1
(43) Pub. Date: Mar. 12, 2015

(54) Controllable Compression Garments Using Shape Memory Alloys And Associated Techniques And Structures

(71) Applicants: Bradley T. Holschuh, Cambridge, MA (US); Dava J. Newman, Cambridge, MA (US); Edward W. Obropta, JR., Cape May Court House, NJ (US)

(72) Inventors: Bradley T. Holschuh, Cambridge, MA (US); Dava J. Newman, Cambridge, MA (US); Edward W. Obropta, JR., Cape May Court House, NJ (US)

(73) Assignee: Massachusetts Institute of Technology, Cambridge, MA (US)

(21) Appl. No.: 14/482,365

(22) Filed: Sep. 10, 2014

Related U.S. Application Data
(60) Provisional application No. 61/876,483, filed on Sep. 11, 2013.
(60) Provisional application No. 61/884,494, filed on Sep. 30, 2013.

(51) Int. Cl. A61H 1/00; B64G 6/00; A62B 17/00

(52) U.S. Cl. CPC A61H 1/008; A62B 17/008; B64G 6/00; A61H 2209/00
USPC 601/84

(57) ABSTRACT

An active compression garment includes at least one passive member to at least partially surround a body part of interest and at least one active actuator member including a shape memory alloy (SMA) that is coupled to the at least one passive member. The at least one active actuator member may be configured to apply compression to, or remove compression from, the body part of interest based on the presence or absence of an applied stimulus.

### CROSS REFERENCE TO RELATED APPLICATION

The present application claims the benefit of U.S. Provisional Patent Application Nos. 61/876,483, filed on Sep. 11, 2013, and 61/884,494, filed on Sep. 30, 2013, which are both incorporated by reference herein in their entireties.

### GOVERNMENT RIGHTS

This invention was made with government support under contract number NNX11AM62H awarded by NASA. The government has certain rights in this invention.

### FIELD

The subject matter described herein relates generally to compression garments and, more particularly, to compression garments and related articles that make use of Shape Memory Alloys.

### BACKGROUND

Compression garments are garments that provide some degree of compression to a body part of a user for a specific purpose. Compression garments may be used in a variety of different applications including, for example, medical applications, sports applications, military applications, space applications, and cosmetic applications. Some medical applications include, for example, compressive stockings to improve circulation in a wearer's legs, compression garments to be worn by diabetes sufferers, compression garments to be worn by burn victims, and post-surgical compression garments to aid in recovery after a surgical procedure. Sports-related compression garments may be used, for example, to improve the delivery of oxygen to an athlete's muscles during a sporting event. In a military application, a compressive tourniquet might be used to reduce blood flow to an injured body part of a wounded soldier. Space-applications may include, for example, compressive space suits to provide required pressurization to an astronaut's body when venturing outside of a spacecraft in space. Cosmetic applications might include girdles, corsets, and other body shapewear. Many other applications for compression garments also exist.

Compression garments are typically implemented in one of two ways. In one approach, these garments are formed of tight fitting passive materials. While lightweight, these garments are usually difficult and time-consuming to get on and off. In another approach, compression garments are fashioned using pneumatically-pressurized bladders. These garments can be put on and taken off relatively easily while the bladder is in a deflated state. However, such garments are typically bulky and restrict movement when inflated. There is a need for compression garments that are capable of overcoming one or more of the disadvantages of these conventional structures.

### SUMMARY

In various embodiments described herein, compression garments and related structures are described that utilize shape memory alloys (SMAs) to provide enhanced operability and performance in compression garment applications. Also described are various techniques and strategies for forming textile materials that can be used in such compression garments. Compression garments described herein may be relatively lightweight, similar to conventional passive garments. These garments may also include the ability to control the pressure applied to the wearer, thus making them easy to don and doff. It is believed that structures disclosed herein represent the first technology that incorporates integrated shape changing materials to create compression textile garments having controllable pressure.

In accordance with one aspect of the concepts, systems, circuits, and techniques described herein, a compression garment comprises: at least one passive member to at least partially surround a body part of interest; and at least one active actuator member that is coupled to the at least one passive member, the at least one active actuator member including a shape memory alloy (SMA) and being configured to apply compression to or remove compression from the body part of interest based on the presence or absence of an applied stimulus.

In one embodiment, the at least one passive member includes at least one flexible passive member.

In one embodiment, the at least one passive member includes at least one rigid or semi-rigid passive member.

In one embodiment, the at least one active actuator member is located within a seam associated with the at least one passive member.

In one embodiment, the at least one active actuator member includes a yarn within a tri-axial braid structure.

In one embodiment, the at least one active actuator member includes at least one of: a zero-degree yarn of the tri-axial braid structure and a circumferential yarn of the tri-axial braid structure.

In one embodiment, the compression garment includes a tourniquet having a flexible cuff and a base unit, the base unit housing one or more SMA coil actuators that are coupled to the flexible cuff through openings in the base unit.

In one embodiment, the base unit of the tourniquet includes direction changing structures to change a direction of forces generated by the one or more SMA coil actuators to a circumferential direction associated with the flexible cuff.

In one embodiment, the at least one passive member includes at least one flexible passive member and at least one rigid or semi-rigid passive member, wherein the at least one active actuator member is coupled between the at least one flexible passive member and at least one rigid or semi-rigid passive member.

In one embodiment, the at least one passive member includes at least two rigid or semi-rigid passive members, wherein the at least one active actuator member is coupled between the at least two rigid or semi-rigid passive members.

In one embodiment, the at least one active actuator member is part of an SMA actuator cartridge having multiple SMA coil segments coupled between two end caps.

In one embodiment, the SMA actuator cartridge further includes an intermediate spacer element located between the two end caps to maintain the multiple SMA coil segments in a desired spatial relationship with respect to one another, wherein the multiple SMA coil segments are substantially parallel to one another when held taut between the end caps.

In one embodiment, the multiple SMA coil segments are all part of a single continuous SMA coil structure.

In one embodiment, the compression garment includes a mechanical counter-pressure (MCP) space suit.

In accordance with another aspect of the concepts, systems, circuits, and techniques described herein, a shape memory alloy (SMA) actuator for use in a compression garment is provided. More specifically, the SMA actuator comprises an SMA coil encapsulated within an elastomeric resin material, wherein the elastomeric resin material is pliable enough to allow the SMA coil to contract and expand.

In one embodiment, the SMA coil is configured to return to a trained state when a stimulus is applied thereto.

In one embodiment, the elastomeric resin material is configured to return the SMA coil to a deformed state when the stimulus is removed from the SMA coil.

In one embodiment, the elastomeric resin material includes a flexible material with a stiffness that is sufficiently low to enable activation, but sufficiently high to provide a restoring force (do-twinning) when deactivated.

In accordance with a further aspect of the concepts, systems, circuits, and techniques described herein, a shape memory alloy (SMA) actuator cartridge for use in a compression garment is provided. More specifically, the cartridge comprises: two passive polymer end caps; and multiple active SMA coil segments coupled between the two passive end caps.

In one embodiment, the cartridge further comprises at least one intermediate spacer member between the two passive polymer end caps to hold the multiple SMA coil segments in a desired spaced relationship with respect to one another.

In one embodiment, the multiple SMA coil segments are all part of a single SMA coil structure.

In one embodiment, the two passive polymer end caps each include structures for use in coupling the SMA actuator cartridge to passive members within a compression garment.

In one embodiment, the multiple active SMA coil segments coupled between the two passive end caps are substantially parallel to one another when the segments are held taut between the end caps.

In one embodiment, the cartridge further comprises terminals for applying an electrical stimulus signal to the multiple active SMA coil segments.

### BRIEF DESCRIPTION OF THE DRAWINGS

The foregoing features may be more fully understood from the following description of the drawings in which:

FIG. 1 is a time-lapse view of the deformation of an SMA wire and its return to a trained shape when a stimulus is applied;

FIG. 2 is a diagram illustrating an exemplary active seam structure that may be used in a compression garment in accordance with an embodiment;

FIG. 3 is a diagram illustrating another exemplary active seam structure that may be used in a compression garment in accordance with an embodiment;

FIG. 4 is a diagram illustrating an exemplary tri-axial braid structure that may incorporate one or more SMA actuator structures in accordance with an embodiment,

FIG. 5 is a diagram illustrating a technique for operating an active tourniquet in accordance with an embodiment;

FIGS. 6 and 7 are diagrams illustrating an exemplary tourniquet structure that may be used to carry out the technique of FIG. 5 in accordance with an embodiment;

FIG. 8 is a diagram illustrating an exemplary compression garment architecture that uses a rigid or semi-rigid passive member along with a flexible passive member to surround and compress a body part in accordance with an embodiment;

FIG. 9 is a diagram illustrating an exemplary compression garment architecture that uses two or more rigid or semi-rigid passive members that are interconnected using SMA actuators to provide compression in accordance with an embodiment;

FIG. 10 is a diagram illustrating an SMA coil actuator encapsulated within an elastomeric material in accordance with an embodiment;

FIG. 11 is a diagram illustrating an SMA coil fabrication process in accordance with an embodiment;

FIG. 12A is a diagram illustrating an exemplary SMA actuator cartridge in accordance with an embodiment;

FIG. 12B is a diagram illustrating an SMA coil embedded within the channels of a partially formed end cap of an SMA actuator cartridge in accordance with an embodiment;

FIGS. 13A and 13B are diagrams illustrating exemplary end caps and an exemplary central spacer that may be used in a single-plastic cartridge at a pre-completion stage and a completion stage, respectively in accordance with an embodiment;

FIGS. 14A and 14B are diagrams illustrating exemplary end cap designs and central spacer designs for an SMA actuator cartridge in accordance with an embodiment; and

FIGS. 14C and 14D are diagrams illustrating exemplary end cap superstructure designs in accordance with embodiments.

### DETAILED DESCRIPTION

Techniques, concepts, and systems described herein relate to compression garments made from a combination of traditional passive textile materials and/or semi-rigid support structures and one or more shape memory alloy (SMA) actuators. Various techniques for forming and using such materials are described herein. In some embodiments, SMA actuators formed from coiled SMA wire materials are used within the SMA enhanced textile materials. It was found that such coiled actuators are capable of providing the controllable forces and shape change attributes necessary for supporting compression for a large number of different compression garment applications. Other forms of SMA actuators may alternatively be used.

As used herein, the term “compression garment” is defined as a garment that is designed to provide compression to a body part of a user for a specific purpose, other than holding the garment on the wearer. Thus, a conventional pair of sox may provide some level of compression to a wearer's legs so that they do not fall down, but these are not considered compression garments. A compression stocking worn by a diabetic to improve circulation, however, is considered a compression garment for purposes of this disclosure. The word “garment” is used herein in a broad sense to encompass anything that may be worn on a body, regardless of size or location, and is not limited to items that are normally considered clothing. Thus, structures like bandages, tourniquets, and the like are considered herein to be garments.

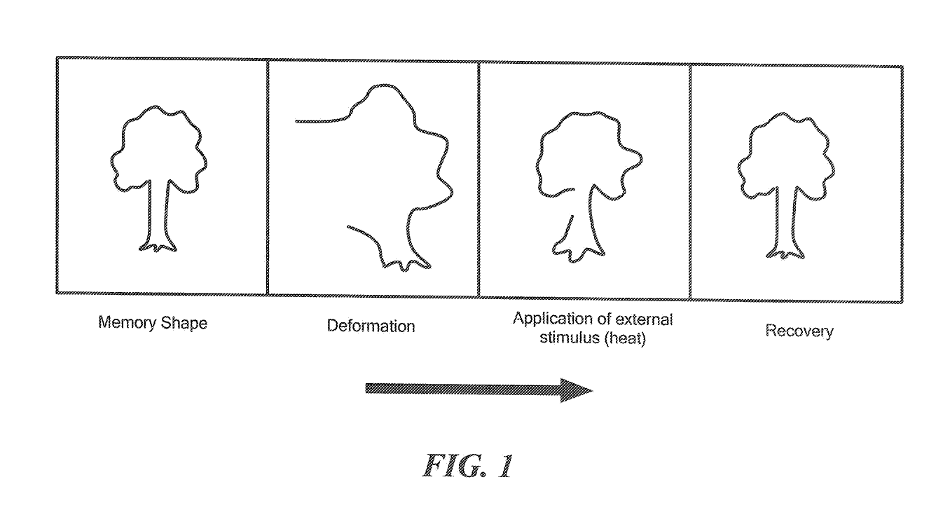

Shape Memory Alloys (SMAs) are a category of metal alloys that demonstrate a shape memory effect, which is the ability to return from a deformed state to a “remembered” state when exposed to a specific stimulus. This occurs as a result of a diffusionless solid-to-solid transformation between the alloy's austenitic and martensitic phases that is triggered by an external stimulus (see J. Madden et al. “Artificial Muscle Technology: Physical Principles and Naval Prospects,” IEEE Journal of Oceanic Engineering, 29, 696-705 (2004)). Stimuli can take several forms, including externally applied stress, heat, or magnetic fields, among others. Shape memory alloys also demonstrate super-elasticity, which is the ability to fully recover its strain throughout a loading and unloading cycle, though hysteresis-based energy losses do occur (Qiao, L., et al., “Nonlocal Superelastic Model of Size-Dependent Hardening and Dissipation in Single Crystal Cu—Al—Ni Shape Memory Alloys”, Physical Review Letters, 106, 085504 1-4 (2011)). The deformations that can be recovered through the shape memory effect are significant. For example, FIG. 1 shows a time-lapse view of an SMA wire, deformed from its original configuration then exposed to heat, causing the sample to return to its original, un-deformed “memory” shape. Both the memory shape and the activation temperature threshold of an SMA element can be tailored for custom applications. The memory shape can be set by annealing the alloy while fixed in the desired shape. The activation temperature may be set by, for example, modifying the alloy mixture.

SMAs have been extensively studied, and their shape memory and elastic properties have proven useful in a wide variety of applications, ranging from robotic actuators and prostheses to bridge restraints, valves, deformable glasses frames, biomedical devices, and even wearable garments (see, e.g., Berzowska, J. et al., “Kukkia and Vilkas: Kinetic Electronic Garments,” Ninth IEEE International Symposium on Wearable Computers, IEEE (2005); Johnson, R. et al., “Large scale testing of nitinol shape memory alloy devices for retrofitting of bridges,” Smart Materials and Structures, 17 (2008); Yang, K. et al., “A novel robot hand with embedded shape memory alloy actuators,” Journal of Mechanical Engineering Science, 216, 737-745 (2002); Lee et al., “Biomedical Applications of Electroactive Polymers and Shape Memory Alloys,” Smart Structures and Materials 2002: Electroactive Polymer Actuators and Devices (EAPAD), IN Bar-Cohen, Y. (Ed.), SPIE; Pfeiffer, C., et al., “Shape Memory Alloy Actuated Robot Prostheses: Initial Experiments,” 1999 IEEE International Conference on Robotics and Automation, Detroit, Mich., IEEE (1999); Lu, A. et al, “Design and Comparison of High Strain Shape Memory Alloy Actuators,” International Conference on Robotics and Automation, Albuquerque, N. Mex., IEEE (1997)). The memory effect has been demonstrated in several alloy types, though the most common and commercially available alloy produced is NiTi (approximately 55% Nickel and 45% Titanium), under brands such as Nitinol® and Flexinol®. Some other alloys include, for example, silver-cadmium (AgCd), copper-aluminum-nickel (CuAlNi), manganese copper (MnCu), and others. Such alloys can be purchased in wire, tube, strip, or sheet form in varying thicknesses and diameters, and their deformation recovery capabilities scale with element size. In the discussion below, the use of NiTi as an SMA will be described. It should be appreciated, however, that other SMA materials may also be used in connection with the techniques, structures, and systems described herein.

To maximize the usefulness of SMA materials, studies have been conducted to determine optimal configurations for large strains and forces, optimal designs for bundle actuation schemes, and functional dependencies on fiber diameters. For example, one study analyzed and optimized SMA actuator bundles consisting of parallel wires of varying diameter (from 100-250 μm), demonstrating forces of up to 38N (see, e.g., De Laurentis, K, et al., “Optimal Design of Shape Memory Alloy Wire Bundle Actuators,” 2002 IEEE International Conference on Robotics & Automation. Washington, D.C., IEEE, 2002). Another study developed and tested a large force SMA linear actuator capable of lifting 100 lbs with a stroke length of 0.8 in (see, e.g., Anadon, J. “Large Force Shape Memory Alloy Linear Actuator,” Department of Mechanical Engineering, University of Florida (2002)). Still another study determined that energy dissipation in SMA wires increases as their diameters decrease, and that both the transformation stresses and temperatures are subject to size effects (i.e., both stress and temperature hysteresis increase with decreasing wire diameters) (see, e.g., Chen, Y. et al., “Size Effects in Shape Memory Alloy Microwires,” Acta Materialia, 59, 537-553. (2010)).

SMAs are widely available and relatively inexpensive. With proper design and manufacturing, SMAs can produce large forces, recover from large deformations, and can be integrated into textiles. A major limitation of SMAs, however, is the small magnitude of recoverable strain. For example, state of the art SMAs demonstrate strains that peak in the single-digit percentage range (see, e.g., Chen, Y. et al., “Size effects in shape memory alloy microwires,” Acta Materialia, 59, 537-553 (2010); and J. Madden et al., “Artificial Muscle Technology: Physical Principles and Naval Prospects,” IEEE Journal of Oceanic Engineering, 29, 696-705 (2004)). This poses challenges for applications that require large stroke lengths. In a controllable compression garment, for example, compression requires constriction of a garment surrounding a body member. This is most easily achieved through length-wise (i.e., circumferential) constriction of a garment's individual active SMA elements. Based on the strain of SMAs alone, for example, it would be difficult to produce the counter-pressure (e.g., 30 kPa) required for a mechanical counter-pressure (MCP) space suit compression garment while also providing for significant shape changing capability (to support donning and doffing). However, it has been found that other useful features of SMAs may be exploited to allow them to produce the required compression with significant active strains (e.g., their superelasticity and large deformation abilities).

As described previously, in various embodiments, controllable compression garments are provided that are formed from textiles that include SMAs. The SMAs may be implemented as SMA actuators that may be incorporated with more conventional passive textile materials. In some implementations, SMA actuators may be available off the shelf for use in such hybrid textile materials. In other implementations, further processing of raw SMA materials (e.g., SMA wire, etc.) may be performed to generate the SMA actuators. In addition to the selection of active SMA materials, a garment architecture must also be selected in which the active materials can be embedded. The architecture selection requires both a consideration of macro-textile physics as well as a study of production methodologies for textile subcomponents (e.g., fibers and threads) as applied to active materials. The architecture must be capable of transforming SMAs from generic actuators to a form appropriate for integration into a wearable, controllable garment.

In the discussion that follows, a number of exemplary hybrid garment architectures are described that can be used with SMA actuators to produce compression garments for use in different compression applications. These hybrid architectures include, for example, (1) an architecture that uses an active seam structure that includes SMA actuators; (2) an architecture that uses a tri-axial braid structure with SMA actuators; (3) an architecture that uses an active tourniquet structure with SMA actuators; (4) an architecture that uses two or more hard or semi-hard passive structures that are coupled together using SMA actuators; and (5) an architecture that uses one hard or semi-hard passive structure that is coupled to a soft, flexible passive structure using SMA actuators. It should be understood that the above-listed architectures represent examples of some exemplary hybrid architectures that may be used in embodiments. Many other hybrid architectures may alternatively be used.

As described previously, in various embodiments, SMA coil actuators are used within hybrid garment architectures. It has been found that coil actuators are capable of providing both high force and large displacement. An SMA coil actuator can be initially trained, for example, as a tightly wound shorter structure. This can be done by, for example, subjecting the coil to high heat. The actuator may then be deformed by lengthening the coil longitudinally. A stimulus may then be applied (e.g., a voltage, an increased temperature, etc.) that will cause the coil to return to its trained dimension. After the stimulus is removed, the coil actuator can be deformed again and the process repeated.

In general, the force that is generated by providing a stimulus to a deformed SMA coil actuator is maximized as the “spring index” C of the coil is minimized. The spring index may be defined as the ratio of the diameter D of the coil to the diameter d of the SMA wire. Traditionally, the minimum manufacturing limit for the spring index C of a coil is about 3. In some embodiments, coil actuators are used that are as close to the minimum spring index as possible. For example, in one implementation, an SMA wire having a diameter of 305 μm was selected (e.g., 305 μm Flexinol® wire, etc.) and this wire was formed into a coil having an average coil diameter D_{avg} of 940 μm. This results in a spring index of 3.08. Among other reasons, this wire diameter was selected to strike a balance between the thickness of the wire and the low-profile nature of the coil. Coils having other spring indexes may be used in other embodiments. It is possible to use SMA coil actuators with all of the above listed hybrid architectures, but other actuator types may alternatively be used.

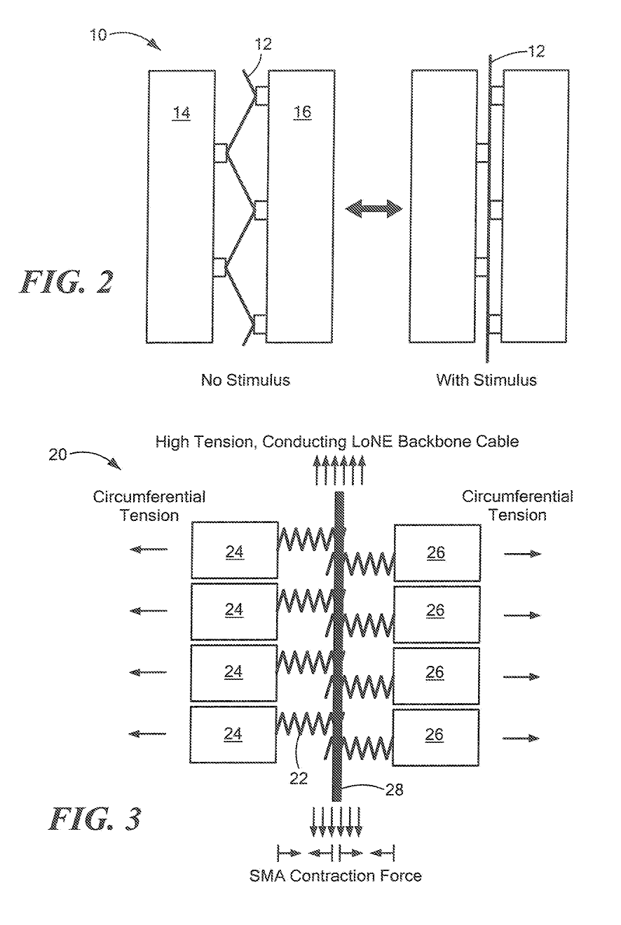

FIG. 2 is a diagram illustrating an exemplary active seam structure that may be used in a compression garment in accordance with an embodiment. As shown, the active seam includes an SMA coil actuator 12 that couples together first and second ends 14, 16 of a passive textile member that may be wrapped about a body part of a wearer. With no stimulus applied, the SMA coil actuator 12 may be deformed into a position that opens the seam, easing donning and doffing. With stimulus, the actuator 12 may return to a trained (i.e., contracted) state that closes the seam and compresses the corresponding body part. When the stimulus is again removed, the seam may again be opened by deforming the SMA coil actuator 12.

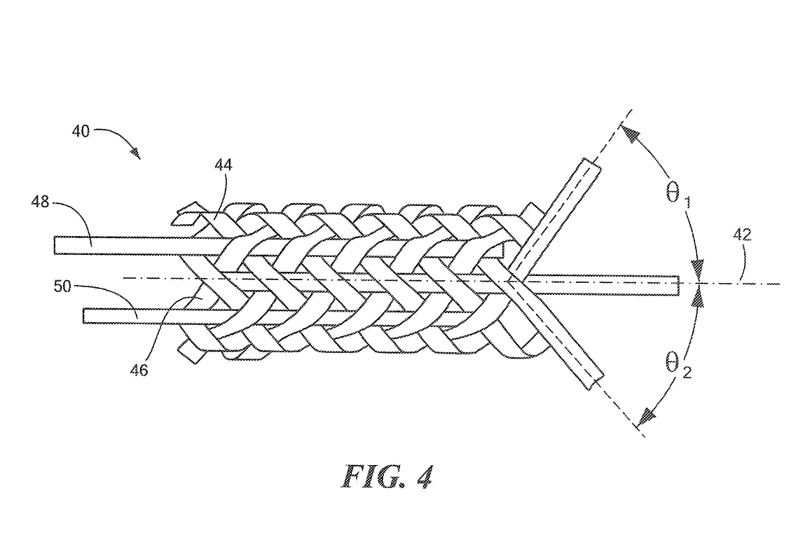

FIG. 3 is a diagram illustrating another exemplary active seam structure 20 that may be used in a compression garment in accordance with an embodiment. In this embodiment, a number of SMA coil actuators 22 are coupled between first and second ends 24, 26 of a circumferentially aligned passive textile member. The actuators 22 may each be coupled between a respective one of the ends 24, 26 of the passive member and a high tension or rigid backbone 28. Alternatively, one or more (or all) of the actuators 22 may be directly coupled between the two ends 24, 26 of the passive member. The backbone 28 (which in one embodiment could be composed of a high tension cable) may be designed to run along a line of non-extension (LoNE) associated with the wearer. The backbone 28 may be formed from a conductive material or contain conductive pathways to allow a control signal to be applied to the actuators 22 to cause them to return to a trained state, thus applying compression to a body part of the wearer. Other active seam configurations may alternatively be used within a compression garment in other implementations.

In some embodiments, SMA coil actuators are used in conjunction with passive braid structures within compression garments. As is well known, a braid is a textile superstructure composed of individual fibers, yarns, or fabric elements that are “mutually intertwined in tubular form” (see, e.g., Demboski, G., et al., “Textile Structures for Technical Textiles Part II: Types and Features of Textile Assemblies,” Bulletin of the Chemists and Technologists of Macedonia, 24, 77-86 (2004)). Several different braiding arrangements (e.g., diamond, regular, Hercules, etc.), axial configurations (e.g., biaxial, triaxial), fiber diameters and porosities, and intertwining angles (e.g., from 10-80 degrees) are possible. Braids are commonly used in a variety of different applications ranging from children's toys (e.g., the Chinese finger trap) to advanced carbon fiber materials. Because of their unique architecture, braided structures have the ability to change both length and diameter, as the fiber elements are free to rotate angularly with respect to one another. For this reason, braided tubes have been utilized in many actuation and morphing engineering structures, including pneumatic artificial muscles, expandable tubing sheaths, and in-vitro stents (see, e.g., Klute, G., et al., “Fatigue Characteristics of McKibben Artificial Muscle Actuators,” Proceedings of the 1998 IEEE/RSJ International Conference on Intelligent Robots and Systems, Victoria, B.C., Canada (1998); Ding, N., “Balloon Expandable Braided Stent with Restraint,” United States (1999); TECHFLEX.COM, http://techflex.com/(2011); Schreiber, F. et al., “Improving the Mechanical Properties of Braided Shape Memory Polymer Stents by Heat Setting,” AUTEXResearch Journal, 10 (2010); and Wang, B. et al., “Modeling of Pneumatic Muscle with Shape Memory Alloy and Braided Sleeve,” International Journal of Automation and Computing, 7 (2010)).

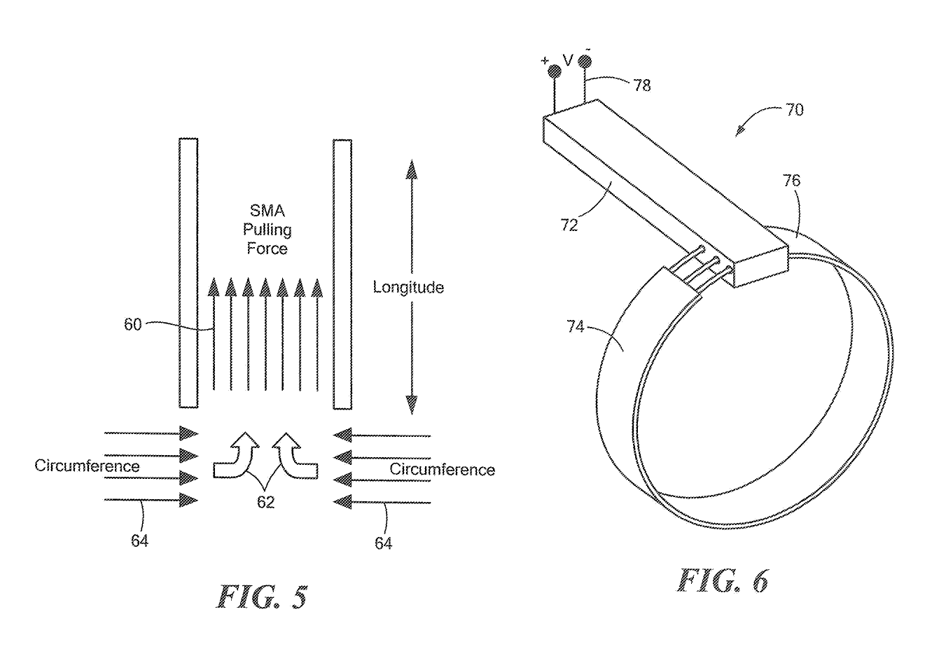

FIG. 4 is a diagram illustrating an exemplary tri-axial braid structure 40 that may incorporate one or more SMA actuator structures in accordance with an embodiment. As shown, the tri-axial braid structure 40 may include positive and negative bias yarns 44, 46 that are intertwined at angles to one another relative to the longitudinal dimension 42 of the braid. In one approach, the positive and negative bias yarns 44, 46 of the braid 40 may be formed of a passive material. The tri-axial braid 40 may also include one or more zero degree yarns 48, 50 and one or more circumferential yarns (not shown). In at least one embodiment, the zero degree yarns 48, 50 (some or all) and the circumferential yarns (some or all) of a tri-axial braid structure 40 may be implemented using SMA actuators or wires. In this approach, the circumferential actuators may be used to, for example, contract the braid structure about a wearer's body part to apply compression thereto. This action will lengthen the braid. The stimulus may later be removed from the circumferential actuators and applied to the zero degree actuators. These actuators then contract, thereby shortening and opening up the braid. The open braid is conducive for easy donning and doffing. In some implementations, only circumferential actuators are used. Using this approach, after a stimulus is removed from the circumferential actuators, human force may be used to open the braid.

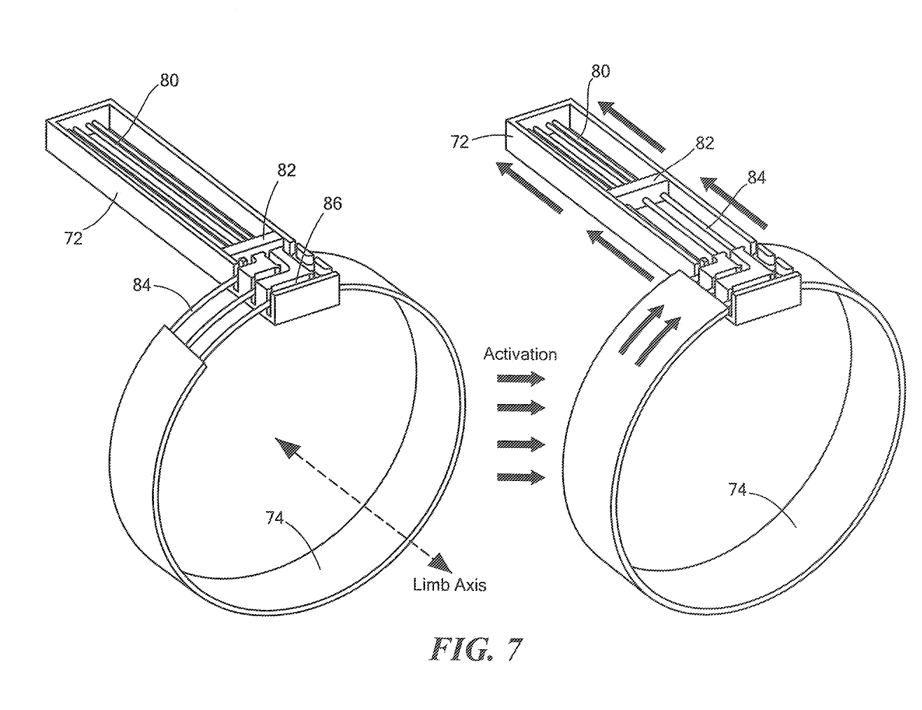

FIG. 5 is a diagram illustrating a technique that may be used to provide a tourniquet incorporating one or more SMA actuators in accordance with an embodiment. The technique allows compression to be applied to a body part of a wearer via a circumferential passive textile element using forces generated by SMA actuators 60 that are oriented in a non-circumferential direction. Using this approach, much longer SMA actuators (e.g., coil actuators) may be used and greater compressive forces may be generated (i.e., the actuators are not limited by the dimensions of the circumferential compressive element). As shown in FIG. 5, to apply compression, a stimulus may be applied to SMA actuators 60 oriented in a longitudinal direction to generate longitudinal forces. Direction changing structures 62 may then be used to change the direction of the generated forces to the circumferential direction 64. These circumferential forces then act to tighten the circumferential passive member (e.g., a cuff, etc.) in a manner that compresses the body part of interest.

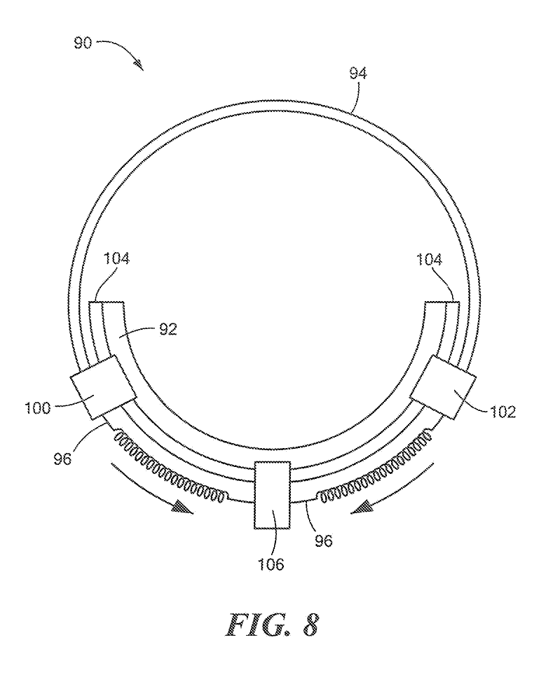

FIGS. 6 and 7 are diagrams illustrating an exemplary tourniquet structure 70 that may be used to carry out the technique of FIG. 5 in accordance with an embodiment. As shown in FIG. 6, a base unit 72 may be provided that houses a number of SMA actuators (not shown). A compressive cuff 74 made out of a passive material may be secured to the base unit 72 at one end 76 thereof. The base unit 72 may also have one or more electrical terminals 78 for the application of a voltage or other stimulus signal to apply compression once the cuff 74 has been fit around a body part. When the stimulus is applied, wires or other structures within the base unit 72 may cause the cuff 74 to tighten around the body part in a desired manner.

FIG. 7 is a diagram illustrating operation of the tourniquet structure 70 of FIG. 6 in accordance with an embodiment. As shown, FIG. 7 includes an internal view of the base unit 72 illustrating multiple SMA coil actuators 80 coupled between an end wall of the base unit 72 and a moveable block 82. Wires 84 are coupled to an opposite side of the moveable block 82. As shown, the wires 84 extend into channel regions 86 within the base unit 72 that change the direction of the wires and the corresponding forces associated therewith. The wires 84 emerge from a side of the base unit 72 where they may be coupled to the cuff structure 74 for applying pressure to a body part of interest. A lid (not shown) may be provided to at least partially enclose the base unit 72 to protect the actuators 80 and other structures therein. Although coil based actuators are used in the illustrated embodiments, it should be appreciated that other actuators types may be used in other implementations. Other structures for changing the direction of the actuator generated forces may also be used.

On the left side of FIG. 7, the tourniquet is shown with the multiple SMA coil actuators 80 de-twinned for donning and doffing. As illustrated, the block 82 is located at an end of an internal cavity of the base unit 72 and wires 84 extend a certain distance outside the base unit 72. On the right side of FIG. 7, the tourniquet is shown with stimulus applied to the SMA coil actuators 80. The stimulus causes the actuators 80 to contract, which pulls the moveable block 82 toward an opposite end of the internal cavity of the base unit 72. This action draws the wires 84 into the base unit 72, thus tightening the cuff 74 around a body part within the cuff (if any). When the stimulus is subsequently removed, a user can manually pull open the cuff for removal from the body part.

Although illustrated with four SMA actuators 80, it should be appreciated that any number of actuators may be used in different implementations. The number of wires 84 that are coupled to the passive cuff 74 do not have to match the number of actuators 80. In some embodiments, a moveable block 82 is not used. For example, the wires 84 that emerge from the base unit 72 may be wires associated with the actuators 80 themselves in some implementations. The wires 84 that emerge from the base unit 72 may emerge on one or both opposing sides of the structure (attaching to one or both ends of the passive cuff). One or more cuffs may be aligned along the length of the base unit, with one or more moveable block/SMA actuator subsystems operating within the base unit.

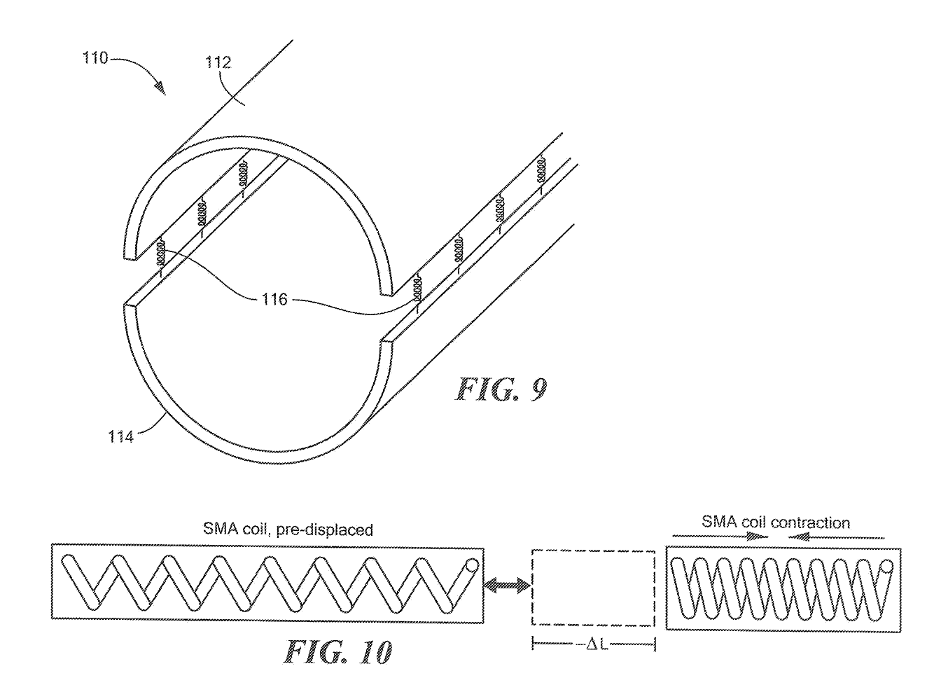

FIG. 8 is a diagram illustrating an exemplary compression garment architecture 90 that uses a rigid (or semi-rigid) passive member 92 along with a flexible passive member 94 to surround and compress a body part in accordance with an embodiment. One or more SMA actuators 96 may be used to provide the forces necessary to move the flexible member 94 with respect to the rigid member 92 to provide compression to a body part inside the structure. As shown, in some embodiments, one or more moveable blocks 100, 102 may be provided that can move along rails 104 associated with the rigid passive member 92. The flexible passive member 94 may be coupled to such blocks 100, 102 at one or both ends thereof. One or more SMA actuators 96 may be coupled between each movable block 102, 104 and a corresponding stationary structure 106 that is fixed to the rigid passive member 92. Any number of actuators 96 may be used and, in some embodiments, parallel arrangements of many actuators may be used.

When a stimulus is applied, the SMA actuators 96 may contract, thereby pulling the flexible passive member 94 into or over, the rigid member 92 (or stretching the flexible passive member 94 towards and adjacent to the rigid member 92) and applying compression to a body part located inside the members 92, 94. In one embodiment, one end of the flexible passive member 94 may be fixed to the rigid passive member 92 and the other end may be moveable. In the illustrated embodiment, both ends of the flexible passive member 94 are moveable with respect to the rigid member 92.

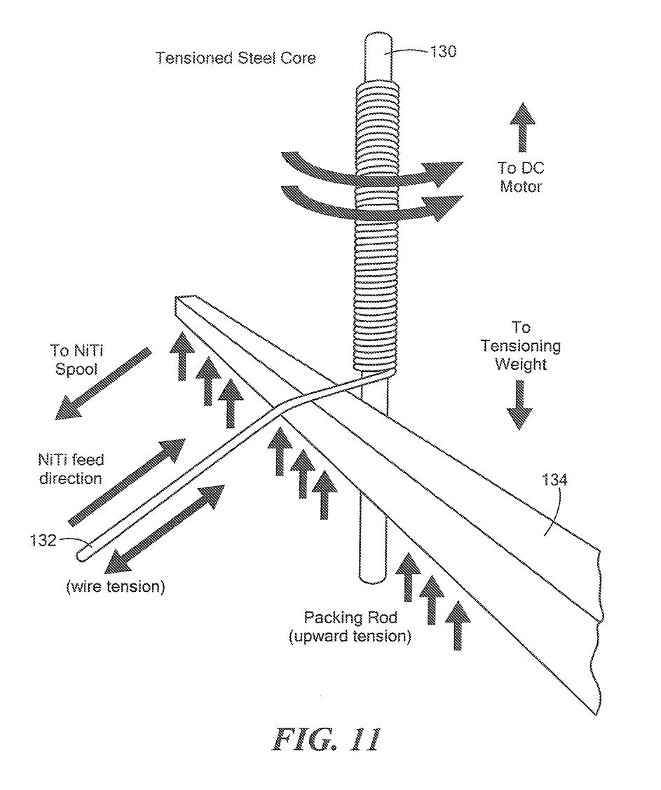

FIG. 9 is a diagram illustrating an exemplary compression garment architecture 110 that uses two rigid (or semi-rigid) passive members 112, 114 that are interconnected using SMA actuators 116 to provide compression in accordance with an embodiment. As shown, when no stimulus is applied, the two members 112, 114 may be pulled apart to allow easy donning and doffing. When the stimulus is applied, the actuators 116 pull the two rigid members 112, 114 together, thus applying compression to a body part of interest. When the stimulus is removed, the rigid members 112, 114 may again be pulled apart for easy doffing. Although not shown, it should be appreciated that mechanical guides may be provided to control the opening and closing of the garment. Similarly, in some implementations, protection structures may be provided to protect the actuators 116 from damage. Additional implementations of this concept using more than two members may alternatively be used. Any number of actuators 116 may be used including, in some embodiments, a large number of parallel actuators. In at least one embodiment, SMA actuators 116 are only used on one seam between the two passive members 112, 114 (e.g., the seam on the right side in FIG. 9). The other seam (e.g., the seam on the left side in FIG. 9) may use passive, flexible materials to provide coupling.

Although not shown in all embodiments described herein, it should be appreciated that structures will typically be provided to allow control signals to be applied to the various SMA actuators. In most cases, the control signals will be electrical signals and the structures that are provided to apply the signals will be terminals, contacts, or leads and corresponding conductor lines that are conductively coupled to each of the actuators to be used. In some embodiments, each individual actuator may be separately controlled. In others, multiple actuators may be coupled together, either in series, in parallel, or some serial/parallel combination, for the purpose of applying control signals. Any technique may be used for providing control signals to the actuators of a garment in various embodiments.

Delivery of control signals may be accomplished using electrified conductive fibers integrated as necessary into the respective textile structures. In some embodiments, non-electrified (thermal) activation of the active structures through conductive heating may be used. In some implementations, for example, simple contact with the wearer may prove sufficient for activation (if the shape changing elements have sufficiently low activation temperatures) requiring no external power or thermal source. In other implementations, direct contact of actuators with an adjacent thermal element may be used to impart thermal energy for activation. The force response of a given SMA coil actuator, when held at a fixed displacement, scales approximately linearly with temperature (and therefore with applied voltage) up to the final activation temperature of the specific material used (and this temperature is modifiable based on the specific shape change material properties and annealing method used in its manufacturing). This enables precision force and displacement control of the system through the applied signals, with enables a specialized compression response that can be tailored for a given application.

In various embodiments described above, compressive garments were described that performed compression when a stimulus was applied, and that were opened or could be physically opened through deformation of the actuators, when the stimulus was removed. In some embodiments, however, the compressive state may occur when the stimulus is not applied. The stimulus may then be used to remove the compression and open the garment. This may be desired, for example, in an application where the compression state is a fail-safe state. For example, in a space application, a space suit will typically have to maintain a pressurized condition while an astronaut is outside a space vehicle. If a power source fails in such a scenario, the space suit has to remain pressurized. Thus, the suit may be configured to provide compression with no signal applied and to relieve compression when a signal is subsequently applied (e.g., when the astronaut returns to the ship and wants to remove the suit).

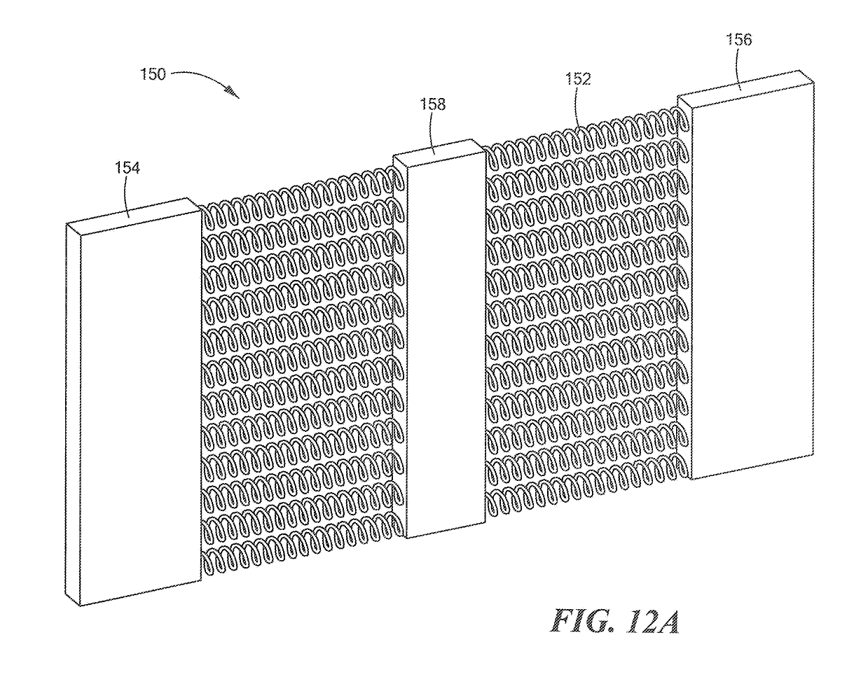

In some embodiments, SMA coil actuators may be encapsulated within an elastomeric material before being placed within one or more compression garments or fabrics, forming a composite fiber. An example of this is shown in FIG. 10. Among other things, this elastomeric material may provide electrical and/or thermal insulation for the actuator to, for example, prevent shorting of the actuator to other actuators and/or other conductive structures, or to provide thermal insulation. The elastomeric material may also provide physical protection to the coil from other potential sources of harm in a corresponding system, and may provide a cylindrical (rather than helical) form factor, which can be advantageous in a textile configuration. At a minimum, the encapsulation material must be pliant enough to allow the SMA coil actuator to compress when a stimulus is applied. In addition, in some embodiments, an encapsulation material is used that is capable of returning to an original shape after the stimulus is removed from the actuator using only forces stored up within the material. In this manner, a two way actuator may be achieved that contracts when stimulus is applied and expands when stimulus is removed. Such an actuator may be used in any of the above described compression garments embodiments.

Several elastomeric materials may be used to achieve the aforementioned shielding and two-way activation. In one embodiment, de-twinned (i.e., extended) coil actuators are cast in cylindrical form (of diameter equal to, or greater than, the coil diameter) in soft silicone resin (e.g., Shore 10 A-30 A hardness) using a precisely machined Teflon cast. Such an actuator has been shown to still achieve activation (i.e., the resin is sufficiently soft to enable contraction without damaging the composite matrix), and it is believed that such actuators will be capable of achieving a repeatable two-way response. Other similar embodiments are possible using a variety of materials, including foam rubber resin, neoprene resin, and other sufficiently soft, insulating elastomers.

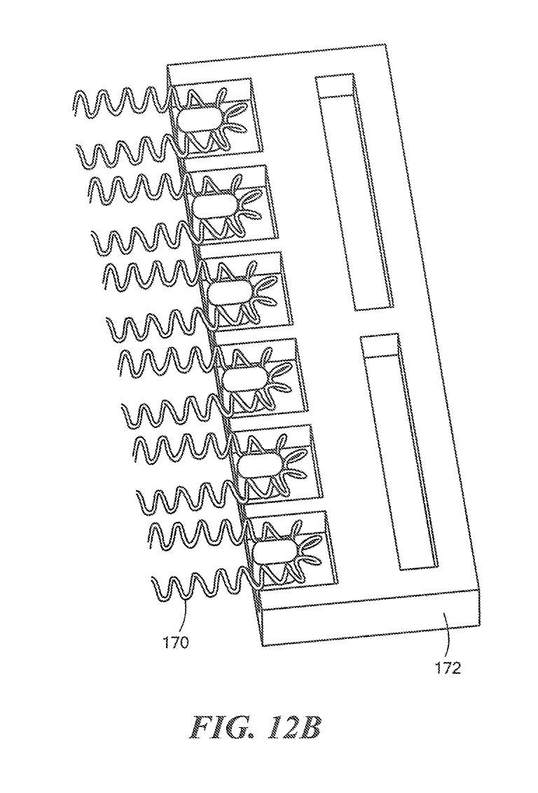

As described previously, in some embodiments described herein, SMA actuators formed from coiled SMA wire materials are used within compression garments. NiTi coils, for example, can achieve displacements that are orders of magnitude greater (>100%) than those of typical axially-aligned SMA wires. The combination of high forces, large displacements, simple activation mechanism, low mass, compact form factor and fiber-like aspect ratio make NiTi SMA coil structures well-suited for inclusion in an active compression textile. To fabricate such coils, a coil winding process is used. One such process that is capable of producing low spring index SMA coil actuators is illustrated in FIG. 11. As shown, the winding may be accomplished by hanging a steel core 130 under tension from a variable speed DC motor, and progressively feeding an NiTi wire 132 along the length of the core 130 using a packing rod 134 as the core 130 rotates. Downward tension may be induced in the NiTi wire 132 manually, and upward tension may be provided by the packing rod 134 at the point of winding to ensure tight packing density and consistent pitch angle. In one implementation, a 305 μm (0.012″) NiTi Flexinol muscle wire was used with a 635 μm (0.025″) stainless steel core, resulting in a spring index C of 3.08. This process was found to repeatably produce coils with average packing density η=0.887 (±0.02, at 95% confidence). The specific NiTi wire diameter (305 μm) was selected as a compromise between maximum force (and therefore maximum pressure) and coil thickness (coil outer diameter). In this case, the outer diameter (˜1.25 mm) determines the bulkiness of the actuator system relative to the passive textile thickness.

Once wound at room temperature, each coil may be clamped on both ends to retain its shape and annealed at 450° C. for 10 minutes to set the austenite memory state. After this, the coil may be water quenched and the steel core and clamps may be removed. These annealing parameters were selected as a balance between minimizing de-twinning force and minimizing permanent plastic deformation after actuation.

NiTi compression coils may be defined by several key parameters, just as any other spring. The parameters include NiTi wire diameter d; spring diameter D, as measured by the midpoint between inner and outer diameters; number of active coils, n; solid spring length, L_{S}, defined as the length of a spring that is fully packed; free spring length, L₀, defined as the zero-load length of the spring (and for our purposes, the length of the SMA actuator when fully actuated with no load); spring pitch, p, defined as the distance between adjacent coils; spring pitch angle, defined as the angle between a given coil and the local horizontal; initial and final extended spring length, Lᵢ and L_{f}, defined in this case as the total extended spring length pre- and post-activation (under no load, L_{f}′L₀); and initial and final linear displacement δᵢ and δ_{f}, defined as the difference between initial and final extended spring length and free spring length. Actuator force follows Hooke's law, and can be expressed in simplified form as follows, where G is the SMA austenite shear modulus:

$$F = k δ = ( \frac{{Gd}^{4}}{8 {D}^{3} n} ) δ .$$

The above equation can be modified to streamline design by defining three non-dimensionalized parameters: packing density, η; actuator extensional strain, ε; and spring index, C. Packing density may be defined as the ratio of the number of active coils contained in the free spring length L₀ relative to the physical limit. This can also be defined as the ratio of the solid spring length L_{S} to the free spring length L₀:

$$η = \frac{{L}_{S}}{{L}_{o}} = \frac{nd}{{L}_{o}}$$

Actuator extensional strain ε may be defined as the ratio of spring displacement δ to free spring length L₀. Spring index C is a universal spring parameter defied as the ratio of spring diameter D to wire diameter d, which is a measure of coil curvature. Substitution then results in the following force equation:

$$F = ( \frac{{Gd}^{2}}{8 {C}^{3} η} ) ε .$$

This equation allows actuators to be designed to meet specific performance requirements, which may include force targets, size limitations, manufacturing limitations, or desired lengths or extensional strains. For example, force may be maximized by maximizing G, d, and ε, and by minimizing C and η. Physically speaking, maximum force may be achieved when an SMA spring actuator is comprised of thick diameter wire wound to the tightest spring index, and is de-twinned to the mechanical limit with the lowest possible packing density. Such a design, however, requires tradeoffs in terms of actuator size and maximum actuator stroke length (i.e., longer stroke lengths can only be achieved when spring index is increased and packing density is increased, and large diameter SMA wire translates to large coil diameter, even with a minimized spring index). Alternatively, actuator design targets can be achieved by scaling the number of actuators used (if it is not possible to satisfy all constraints with a single actuator). However, increasing the number of actuators in a given system creates both a larger system footprint and greater power requirement. Therefore, specific consideration of each design variable must be given when engineering a system for a desired application.

In various embodiments, high force creation is desirable for morphing wearable structures using SMA coil actuators. Therefore, high force generation may be prioritized over other design variables (e.g., to create maximum counter-pressure) in some implementations. The following criteria may be used to achieve maximum (or near maximum) force:
(1) Maximize force by minimizing spring index C. A physical limit to the sharpness of curvature of a spring actuator exists, below which the material experiences structural damage (see, e.g., “An Optimization Process for Extension Spring Design” by Paredes et al., Comput. Methods Appl. Mechanics and Eng., 191(8):783-797, 2001; “Shigley's Mechanical Engineering Design” by Budynas et al., McGraw-Hill New York, 2008; and “Mechanical Design of Machine Elements and Machines”, by Collins et al., John Wiley and Sons, 2009). Actuators may be selected that match this minimum (C=3);
(2) Maximize force by selecting large d, within reason for a wearable system. While actuator force scales with the square of wire diameter (meaning that a maximum wire thickness should be used if force is to be purely maximized), this cannot be simply maximized due to design constraints associated with wearable garments (e.g., overly-thick actuators may encumber the wearer, and this concern necessitates the design requirement of MCP garment thickness ≦5 mm). Commercial NiTi wire is available as thin as d=25 μm, and as thick as d=510 μm. Reasonably large SMA wire diameters (e.g., d=305 μm) may be selected to balance this tradeoff;
(3) Enable large extensional strains ε by selecting high packing densities η. In addition to large active forces, MCP compression suits require significant active stroke lengths to accommodate donning and doffing prior to active compression. These requirements cannot both be maximized, in terms of selecting appropriate η and ε values (i.e., increased force calls for minimizing η, while increased stroke length calls for maximizing η because doing so increases maximum ε). Consequently, maximum η for a fixed C may be selected to provide as much extensional strain margin as possible (see, e.g., “Low Spring Index NiTi Coil Actuators for use in Active Compression Garments,” by Holschuh et al., IEEE Transactions on Mechatronics, vol. PP, issue 99, Jun. 25, 2014).

One challenge in developing active compression garments using SMA actuators is to design a packaging solution for the SMA actuators themselves. While individual actuators have been shown to produce sizable forces when a voltage is applied, the magnitude of force required for some compression garment applications (e.g., MCPs, etc.) may only be achieved when several actuators are aligned in parallel. In such a configuration, it is advantageous to minimize the space between actuators (i.e., to pack them as close together as possible) because this maximizes the total force produced per unit width. However, this introduces new design challenges such as, for example, preventing the actuators from short-circuiting; sufficiently fixing the actuators in place to prevent structural failure (e.g., an actuator breaking free) during operation (especially at high tension/pressure levels); and successfully mating the actuators to the passive fabric.

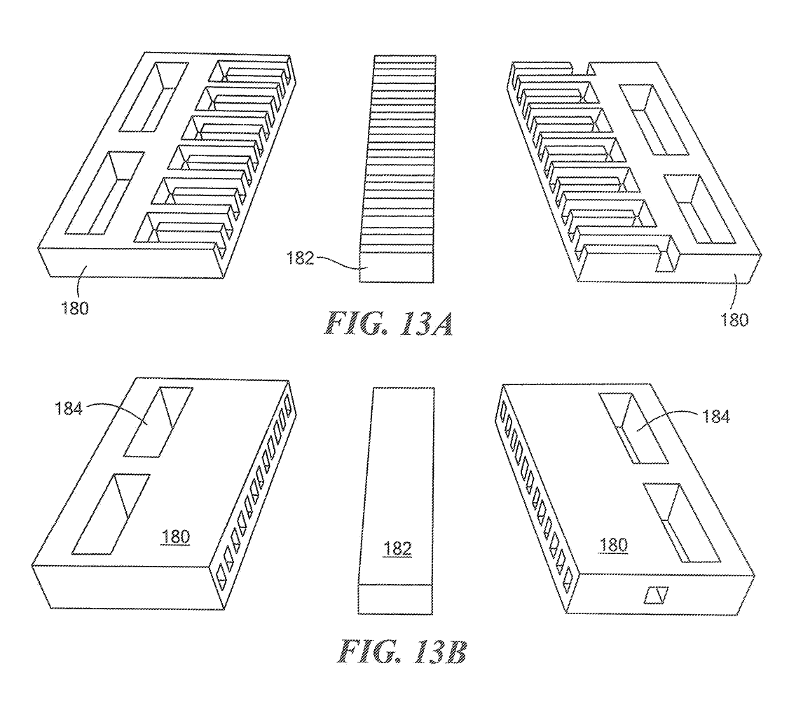

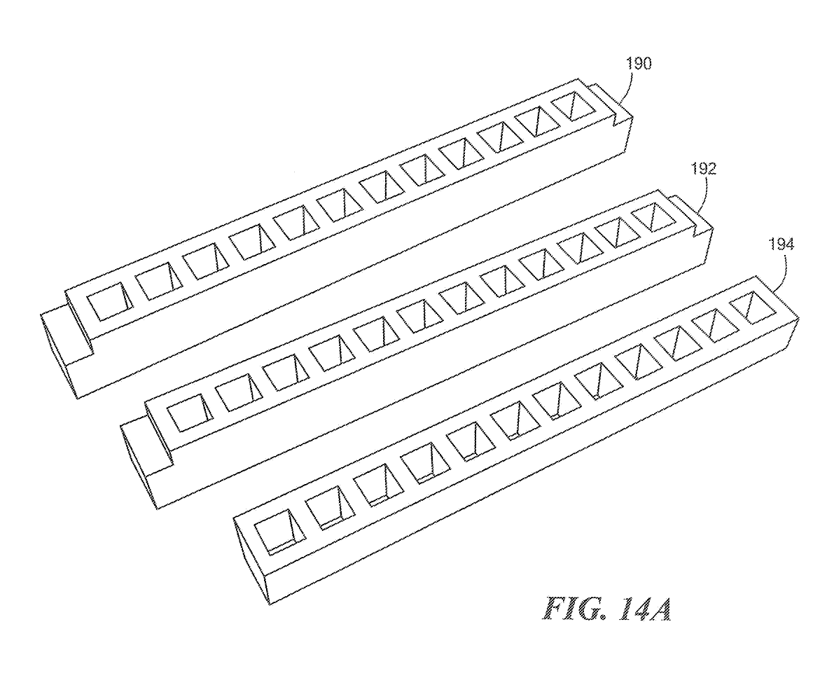

In some implementations, SMA actuators are packaged as a cartridge-style SMA actuator structure that may be used in active compression garments and other applications. An SMA actuator cartridge may include, for example, a self-contained actuator assembly that includes multiple parallel SMA coil segments that may be activated in unison. A SMA actuator cartridge may also include structures that are easily mated to passive textile portions of a compression garment. FIG. 12A is a diagram illustrating an exemplary SMA actuator cartridge 150 in accordance with an embodiment. As illustrated, the SMA actuator cartridge 150 may include: a singular, extended, and de-twinned SMA coil 152 that is held within two polymer end caps 154, 156 and a central polymer spacer 158. In at least one implementation, the end caps 154, 156 and the central spacer 158 are formed by a 3-dimensional (3D) printer, although other construction techniques may alternatively be used. Although described above as having a singular SMA coil 152, it should be appreciated that SMA actuator cartridges that include multiple separate SMA coils may also be provided in different embodiments. In some implementations, multiple separate SMA coils may be held in a substantially parallel arrangement within an SMA actuator cartridge. Also, in some implementations, multiple intermediate spacer elements may be provided between end caps in a cartridge structure, rather than a single central spacer as shown in FIG. 12A. In at least one embodiment, two end caps are used within a cartridge without an intermediate spacer element.

In the illustrated embodiment, the SMA coil 152 is laced between the two end caps 154, 156 and the central spacer 158 twelve times, resulting in an actuator cartridge 150 with 12 parallel coils that are equally spaced. As will be appreciated, any number of parallel coil segments may be used in any particular implementation. Because the cartridge 150 is comprised of a singular actuator 152 (instead of 12 individual actuators), both electrical conductivity and actuator structural integrity are guaranteed (i.e., the series circuit cannot be compromised unless the actuator wire breaks, and no actuators can individually pull free of the structure, barring failure of the wire or end cap structure itself). In addition, given the flexibility in design of the 3D-printed end caps, a variety of designs are possible for mating the cartridge to adjoining passive fabrics.

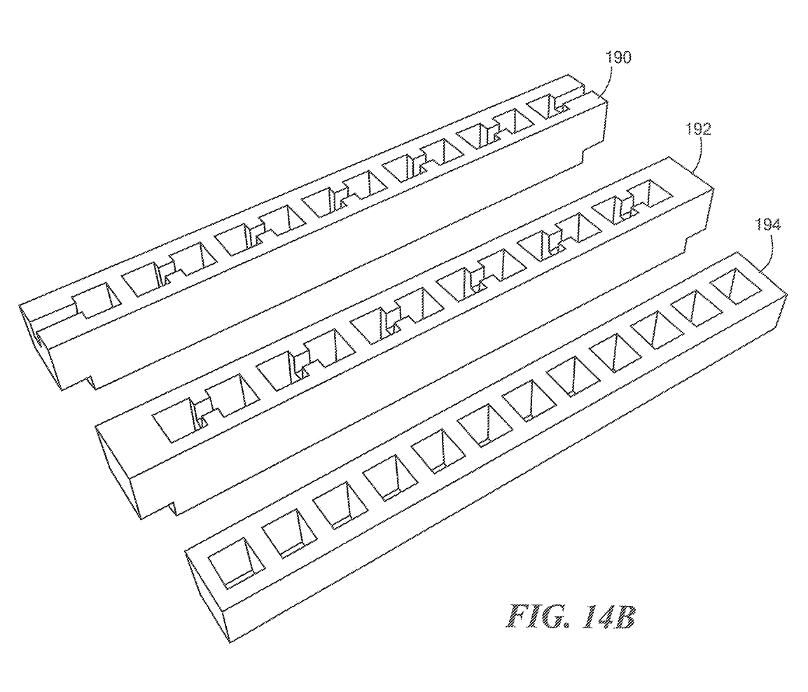

Two exemplary methods for manufacturing actuator cartridges, such as cartridge 150 of FIG. 12A, will now be described. Both of these methods utilize current 3D printing capability. In a first technique, a single-plastic, fully embedded SMA cartridge is provided. Using this approach, an SMA actuator cartridge is produced that is fully encased in homogeneous ABS plastic in a single step, part-way through the 3D printing build phase. The 3D printed end caps and spacer are designed with narrow channels (i.e., channels having a smaller diameter than that of the SMA coil). The SMA coil is forcibly laced/embedded in these channels at a pause part-way through the build. This may be performed using, for example, a manual tool, such as a flat-head screwdriver or the like, to jam the coil into each channel to lock it in place (although automated processes may also be developed). FIG. 12B is a diagram illustrating an SMA coil 170 embedded within the channels of a partially formed end cap 172 in this manner in accordance with an embodiment. Once the SMA coil is embedded, the 3D print may be resumed, and several layers of ABS plastic may be deposited over the top the actuator cartridge to fully encase the coil in place. FIGS. 13A and 13B illustrate exemplary end caps 180 and an exemplary central spacer 182 that may be used in a single-plastic embodiment at a pre-completion stage (FIG. 13A) and a completion stage (FIG. 13B) (to simplify illustration, the SMA coil is not shown). As illustrated, the end caps 180 may include openings 184 that may be used to mate the cartridge to adjoining passive fabrics (other mating structures may alternatively be used). In at least one implementation, the above-described technique was performed using a Stratasys Fortus 250mc printer, although other similar 3D printers may alternatively be used.

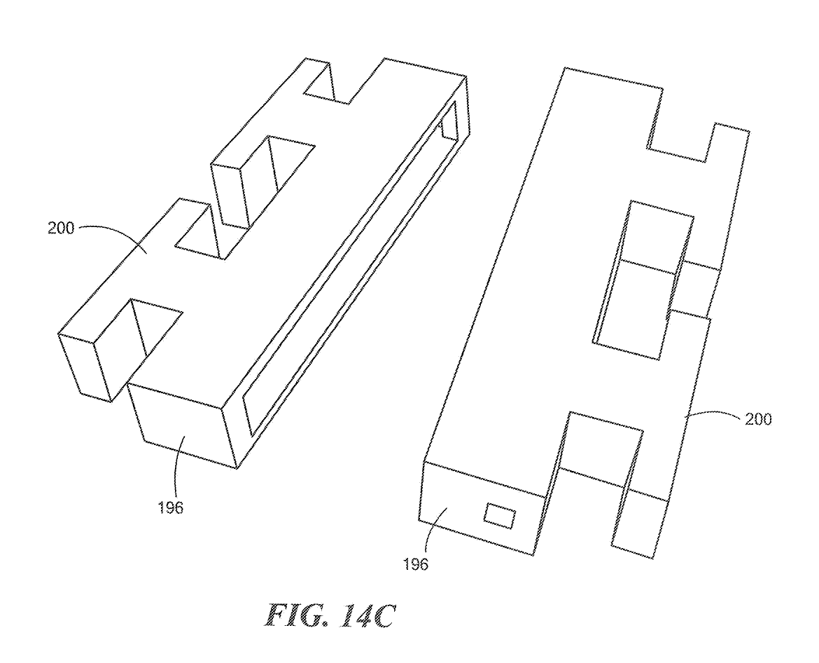

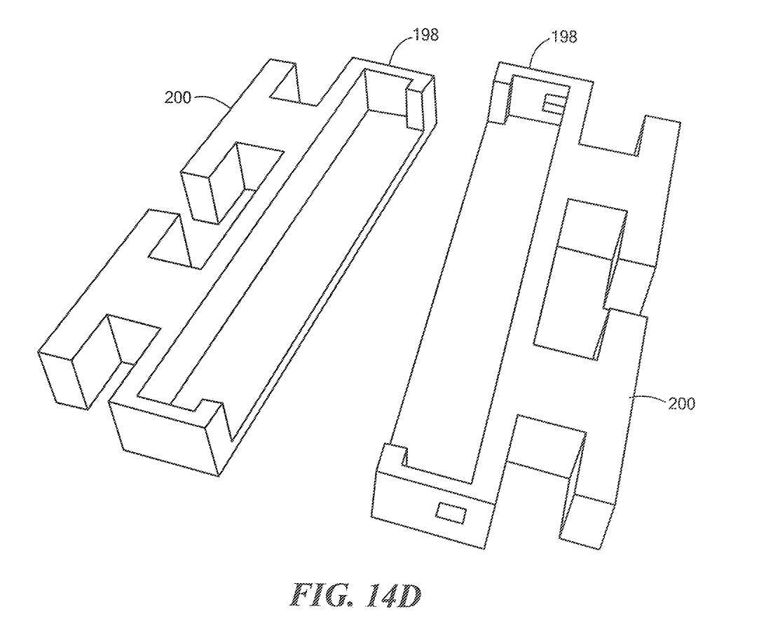

In another technique, a multi-plastic, two piece SMA cartridge is provided. Using this approach, three 3D printed structures (two end cap channel insets and a central spacer) are designed with wide channels that are wider than the diameter of the SMA coil. The SMA coil is loosely laced through these structures resulting in an unfinished cartridge that resembles the final cartridge dimensions, but with little structural stability. The stipulation that the channels be wider than the coil diameter is to ensure that it is possible to lace the coil through the finished channels (post-fabrication). The end caps and central spacer may be prefabricated using a high temperature plastic (such as, for example, ULTEM 9085 or the like), using standard procedures on a Stratasys Fortus 400mc printer or functional equivalent printer. FIGS. 14A and 14B are a top view and a bottom view illustrating exemplary designs of end caps 190, 192 and a central spacer 194 for a multi-plastic cartridge in accordance with an embodiment.

In addition to the end caps and central spacer, 3D printed ABS end cap superstructures may be provided with a strategically designed cavity that matches the shape of the end cap insets. As is done in the single-plastic method described above, the 3D print build may be paused part-way through the process and the end cap insets with the interlaced SMA coil may be inserted into respective cavities of the ABS end cap superstructures. Once this is completed, the build may be resumed, thus encasing and fixing the ULTEM end cap insets in the ABS end cap superstructures. FIGS. 14C and 14D illustrate exemplary designs of end cap superstructures 196, 198 in accordance with different embodiments. As shown, the end cap superstructures 196, 198 may include protrusions 200 to facilitate connection of the resulting cartridge to a passive fabric material.

While both of the above-described fabrication techniques produce functional actuators, they differ in terms of their relative structural stability, actuator spacing, and durability. The single-plastic method, for example, produces a structurally superior and simpler actuator, due to several factors. First, the end caps are made in a single build and of a single material. Second, the actuators are physically locked in place both by friction and as a result of being encased in plastic during the build. Third, the structure is more resilient to cracking and other failures than the multi-plastic design. In addition, because the actuator can be embedded when the structure is incomplete (allowing for much narrower channels than would otherwise be feasible), the actuator spacing approaches the physical limit given the capabilities of modern 3D printers. For example, in a 1-inch wide cartridge, assuming a minimum wall width of 0.03″ between actuator segments, it is possible to fit 12.65 actuator segments of the above-described size in the cartridge. Conversely, the multi-plastic cartridge can only pack 12 actuators into a 1.485″ width, which is a significantly smaller packing density.

The above notwithstanding, the single-plastic design was found to fail in some instances during SMA activation as a result of the ABS plastic exceeding its glass transition temperature (T_{g}=105° C.). This glass transition temperature is significantly lower than the SMA austenite finish temperature. The multi-plastic design, on the other hand, is not susceptible to thermally induced failure as the ULTEM glass transition temperature (T_{g}=186° C.) is greater than the SMA austenite finish temperature. In effect, the ULTEM end cap insets shield the ABS superstructure from high temperatures during activation, preventing thermally-induced structural failure. However, the thermal stability comes at the expense of certain structural stability. That is, the ABS end cap superstructures in the multi-plastic cartridges were found to crack more easily than their single-plastic counterparts, due to stress concentrations at the ULTEM-ABS.

In various embodiments, SMA actuator cartridges such as those described above, are coupled to passive textile materials to produce compression garments and the like. For example, in some embodiments, the cartridge 150 of FIG. 11 may be coupled to opposite ends of a fabric member to form a tourniquet (e.g., similar to tourniquet 70 of FIG. 6). The cartridge 150 (or similar cartridges) may also be used to develop other types of compression garments. In fact, SMA cartridges such as cartridge 150 may be used to replace the SMA actuators in many of the compression garment arrangements discussed above.

In some embodiments, SMA actuator cartridges may be incorporated with passive textiles to form mechanical counter-pressure (MCP) space suits or other full body compression suits. In these applications, the mobility of the suits can be improved by strategically designing the suits to exploit the skin's natural lines of non-extension (LoNE). These lines represent contours on the human body that do not change length during natural motion (meaning as the skin stretches and deforms during movement, no tension or compression forces act along these specific contours). In some implementations, the integrated elements may be aligned with LoNE contours to provide wiring and pressure production capabilities that do not interfere with the mobility of the wearer. Other types of compression garments that utilize SMA actuator cartridges and other SMA actuator structures also exist.

It has been proposed by previous research that in order to create a full-body, highly mobile pressure suit, it may be necessary to map the restraint patterns of the garment to align with the natural lines of non-extension (LoNE) of the wearer's body (see, e.g., Bethke, K., “The Second Skin Approach: Skin Strain Field Analysis and Mechanical Counter Pressure Prototyping for Advanced Space Suit Design,” Aeronautics and Astronautics, Cambridge, Mass., Massachusetts Institute of Technology (2005); and Iberall, A., “The Experimental Design of a Mobile Pressure Suit,” Journal of Basic Engineering, 251-264 (1970)). These lines, which map contours of minimum stretch/contraction of the human skin as the body moves through its range of motion, signify potential patterns for any semi-rigid structural elements of the garment. By integrating such elements along the LoNE, the elements are less likely to be exposed to significant in-line stresses during movement. Such patterning has been proposed for things like integrated bio-sensing equipment in an MCP suit, but they may also be utilized to guide the implementation of active materials designed to augment total body compression capabilities.

Although described above as applying compression to body parts of wearers, it should be appreciated that the structures and techniques described herein may also be used to provide compression to structures in other compression applications. For example, the ability for a system to remotely constrict around an object has potential application in flow control (e.g., pumping systems), gasket/mechanical joining elements, as morphing surface coverings for robotic, aerospace, or architectural systems, and/or in other applications.

Although some structures discussed herein are described as applying compression to a single body part, or only a portion of a body part, it should be appreciated that the disclosed structures may be replicated and interconnected to generate full garments for users (e.g., a compressive shirt, compressive pants, a full body suit, etc.). Also, a single compression garment may be manufactured using multiple of the above-described active compressive structures in some embodiments.

Having described exemplary embodiments of the invention, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

What is claimed is:

1. A compression garment comprising:
at least one passive member to at least partially surround a body part of interest; and
at least one active actuator member that is coupled to the at least one passive member, the at least one active actuator member including a shape memory alloy (SMA) and being configured to apply compression to or remove compression from the body part of interest based on the presence or absence of an applied stimulus.

2. The compression garment of claim 1, wherein:
the at least one passive member includes at least one flexible passive member.

3. The compression garment of claim 1, wherein:
the at least one passive member includes at least one rigid or semi-rigid passive member.

4. The compression garment of claim 1, wherein:
the at least one active actuator member is located within a seam associated with the at least one passive member.

5. The compression garment of claim 1, wherein:
the at least one active actuator member includes a yarn within a tri-axial braid structure.

6. The compression garment of claim 5, wherein:
the at least one active actuator member includes at least one of: a zero-degree yarn of the tri-axial braid structure and a circumferential yarn of the tri-axial braid structure.

7. The compression garment of claim 1, wherein:
the compression garment includes a tourniquet having a flexible cuff and a base unit, the base unit housing one or more SMA coil actuators that are coupled to the flexible cuff through openings in the base unit.

8. The compression garment of claim 7, wherein:
the base unit of the tourniquet includes direction changing structures to change a direction of forces generated by the one or more SMA coil actuators to a circumferential direction associated with the flexible cuff.

9. The compression garment of claim 1, wherein:
the at least one passive member includes at least one flexible passive member and at least one rigid or semi-rigid passive member, wherein the at least one active actuator member is coupled between the at least one flexible passive member and at least one rigid or semi-rigid passive member.

10. The compression garment of claim 1, wherein:
the at least one passive member includes at least two rigid or semi-rigid passive members, wherein the at least one active actuator member is coupled between the at least two rigid or semi-rigid passive members.

11. The compression garment of claim 1, wherein:
the at least one active actuator member is part of an SMA actuator cartridge having multiple SMA coil segments coupled between two end caps.

12. The compression garment of claim 11, wherein:
the SMA actuator cartridge further includes an intermediate spacer element located between the two end caps to maintain the multiple SMA coil segments in a desired spatial relationship with respect to one another, wherein the multiple SMA coil segments are substantially parallel to one another when held taut between the end caps.

13. The compression garment of claim 11, wherein:
the multiple SMA coil segments are all part of a single continuous SMA coil structure.

14. The compression garment of claim 1, wherein:
the compression garment includes a mechanical counter-pressure (MCP) space suit.

15. A shape memory alloy (SMA) actuator for use in a compression garment, comprising:
an SMA coil encapsulated within an elastomeric resin material, wherein the elastomeric resin material is pliable enough to allow the SMA coil to contract and expand.

16. The SMA actuator of claim 15, wherein:
the SMA coil is configured to return to a trained state when a stimulus is applied thereto.

17. The SMA actuator of claim 16, wherein:
the elastomeric resin material is configured to return the SMA coil to a deformed state when the stimulus is removed from the SMA coil.

18. The SMA actuator of claim 15, wherein:
the elastomeric resin material includes a flexible material with a stiffness that is sufficiently low to enable activation, but sufficiently high to provide a restoring force when deactivated.

19. A shape memory alloy (SMA) actuator cartridge for use in a compression garment, the cartridge comprising:
two passive polymer end caps; and
multiple active SMA coil segments coupled between the two passive end caps.

20. The SMA actuator cartridge of claim 19, further comprising:
at least one intermediate spacer member between the two passive polymer end caps to hold the multiple SMA coil segments in a desired spaced relationship with respect to one another.

21. The SMA actuator cartridge of claim 19, wherein:
the multiple SMA coil segments are all part of a single SMA coil structure.

22. The SMA actuator cartridge of claim 19, wherein:
the two passive polymer end caps each include structures for use in coupling the SMA actuator cartridge to passive members within a compression garment.

23. The SMA actuator cartridge of claim 19, wherein:
the multiple active SMA coil segments coupled between the two passive end caps are substantially parallel to one another at least when the segments are held taut between the end caps.

24. The SMA actuator cartridge of claim 19, further comprising:
terminals for applying an electrical stimulus signal to the multiple active SMA coil segments.
